(19) United States
(12) Patent Application Publication
(10) Pub. No.: US 2015/0348371 A1
(43) Pub. Date: Dec. 3, 2015

(54) ROBOTIC SYSTEM FOR USE IN GAMING ENTERTAINMENT ENVIRONMENT

(71) Applicant: Mladen Blazevic, New York, NY (US)

(72) Inventor: Mladen Blazevic, New York, NY (US)

(21) Appl. No.: 14/725,031

(22) Filed: May 29, 2015

Related U.S. Application Data
(60) Provisional application No. 62/005,524, filed on May 30, 2014.

(51) Int. Cl. G07F 17/32

(52) U.S. Cl. CPC G07F 17/3288; G07F 17/3293; G07F 17/3248; G07F 17/3225

(57) ABSTRACT

A system for providing a method of entertainment to players of competitive card games using:
a) a source of randomized physical or virtual playing cards;
b) a processor having knowledge or no knowledge of card rank and suit order in the randomized playing cards;
c) the processor containing memory of game strategy for the competitive card games;
d) a mechanical or electromechanical card moving system for providing randomized playing cards to a player position and a dealer position;
e) a player input for providing wagers in the competitive card games;
f) the processor configured to exercise code to perform wagering events in the competitive card game based upon knowledge of card rank and suit order in the randomized playing cards and performance of the stored game strategy; and
g) the processor resolving wagers made in the competitive card games at conclusion of rounds of play in the competitive card games.

This application claims priority from U.S. Provisional Patent Application No. 62/005,524, filed 30 May 2014.

### BACKGROUND OF THE INVENTION

1. Background of the Art

The present invention relates to the field of entertainment, particularly mechanically assisted entertainment that can simulate or enable playing card gaming between a player position and a dealer (house or banker) position. The dealer position may be represented by a robotic simulation of a dealer.

2. Background of the Art

Public entertainment machines have been available for centuries. Puppets, marionettes, automatons, jack-in-the-boxes, and fortune-telling machines have been attractive at fairs, circuses, carnivals and other entertainment events.

Robotic and interactive devices (with processor controlled movement and displays) have become an important part of the entertainment industry. In the gaming industry, automated roulette wheels, automated dice throwing machines and the like have been used for a relatively short period of time. These machines merely replicate ordinary play (sometimes with electronic wagering) of these standard casino games, and often reduce player entertainment value through elimination of casino personnel interaction without any other way of increasing entertainment value from play on the devices.

U.S. Pat. No. 6,403,908 (Stardust) discloses an automated method and apparatus for sequencing and/or inspecting decks of playing. The method and apparatus utilizes pattern recognition technology or other image comparison technology to compare one or more images of a card with memory containing known ‘good’ images of a complete deck of playing cards to identify each card as it passes through the apparatus. Once the card is identified, it is temporarily stored in a location corresponding to or identified according to its position in a properly sequenced deck of playing cards. Once a full set of cards has been stored, the cards are released in proper sequence to a completed deck hopper. The method and apparatus also includes an operator interface capable of displaying a magnified version of potential defects or problem areas contained on a card which then may be viewed by the operator on a monitor or screen and either accepted or rejected via operator input. The patent is also capable of providing an overall wear rating for each deck of playing cards. In order to certify that deck of playing cards is good and acceptable for play, the casino must ascertain that: (1) there is one and only one of each type (i.e. by suit and rank) of playing card in the deck of playing cards, (2) all of the backs of the playing cards contained in the deck are of the same color, (3) there are no defective playing cards (i.e. torn or cracked cards, cards with dimples or fingernail marks, cards with missing print or cards with spots), and (4) there are no boxed cards (cards facing backwards, etc.) contained in the deck of playing cards. Imaging cameras are used to obtain one or more images of each side of the card after the double card check is made. A low resolution image is made of the front to determine suit and rank and back to determine color of the card. Generally, high resolution imaging is utilized to determine fine marks and problems. If the system is not in an inspect mode, it is possible to use the cameras simply to image a corner of the card, since the information necessary as to color and suit and rank is available in this portion of each card.

U.S. Pat. No. 5,941,769 (Order) discloses that in professional use in table games of chance, playing cards are provided which will register and evaluate all phases of the run of the game automatically. This is achieved by a card shoe with an integrated device for recognition of the value of the drawn cards (optical recognition device and mirroring into a CCD-image converter); photodiodes arranged under the table cloth to register separately the casino light passing through each area for placing the gaming chips and areas for placing the playing cards in dependence of the arrangement or movement of the chips and playing cards on the mentioned areas; a device for automatic recognition of each bet (scanner or a RFID-system comprising a S/R station and gaming objects with integrated transponder); an EDP program created in accordance with the gaming rules to evaluate and store all data transmitted from the functional devices to the computer; and a monitor to display the run of the game and players' wins.

U.S. Pat. No. 5,770,533 (Franchi) describes a casino operating system for controlling the flow of funds and monitoring gambling activities in a casino or a gaming establishment utilizing a network of computers, including a central computer and individual game computers. Each player receives an encoded betting card from the cashier. At the games, each player position is equipped with a control panel including a card reader into which the betting card is inserted. The control panel also includes an electronic screen and keyboard. From the control panel, the player may place a bet and perform all options available to the player in the particular game. The system records the hands dealt to each player and the winner, and credits or debits the player's betting card accordingly. In an alternative embodiment, the casino operating system allows the players to use chips to place bets instead of the above-described betting card. The chips are marked or encoded so that they can be counted once final bets have been placed to determine the amount of each player's bet. In games requiring the placement of bets in certain positions on the gaming table, each player may be provided with a betting marker used to indicate the position of his bets on the table, a touch-sensitive screen maybe used whereby bets are placed by touching the desired position on the screen, or a two-way remote control console for placing bets. The casino operating system is an open architecture system adaptable to accommodate the differing needs of each casino.

U.S. Pat. No. 4,531,187 (Uhland) describes a system for monitoring the play at gambling games. The preferred embodiment comprises a system for monitoring the play at blackjack as that game is played in casinos. The system typically will comprise video monitor means for generating a digital representation of the bets made by the players and of the cards dealt to the players and to the dealer, so that an output can be generated indicating whether the correct payouts are made and bets collected. An alarm signal is generated if an error is made in the play of the game. An alarm signal may also be generated if the long-term statistics of the game indicate that the odds ordinarily applicable to the game have been departed from over a period of time.

U.S. Pat. No. 8,221,244 (French) describes methods and systems for intelligent tracking and/or play and/or management of card gaming use an intelligent card distribution or holding device with detectors for determining the value and unique identity of individual cards and for recording card play. Playing cards are equipped with a read/write data storage connected to a transponder and/or incorporated into electromagnetic writable particles or smart particles (smart dust). A system of the invention records various game play events on the playing cards themselves during game play and optionally also in a database on the system. In specific embodiments, the principal scanning and writing elements and electronic and optical interfaces are embodied into a hand-held card holder (HHCH). The system can scan playing cards, scan gaming chips, indicate a player's win/loss/draw, increase or decrease player betting positions, and compute awards to players based on their playing activity.

U.S. Pat. No. 7,967,672 (Shigeta) describes a card reading device that comprises a rail for guiding a card; card sensors for detecting a passing card which is slid by hand and guided by the rail, which are placed in a card sliding direction with a certain gap; and reading sensors for reading code attached to the card, which are placed between the two card sensors in the card sliding direction. The cards have the code which is printed in UV-luminous ink on the card, and the code comprises at least two code rows which are placed across the card sliding direction with a certain gap. The two reading sensors are placed in positions which correspond to the gap of the two code rows, and the card sensors output signal for detecting a position of the passing card.

U.S. Pat. No. 6,629,894 (Purton) describes a card inspection device that includes a first loading area adapted to receive one or more decks of playing cards. A drive roller is located adjacent the loading area and positioned to impinge on a card if a card were present in the loading area. The loading area has an exit through which cards are urged, one at a time, by a feed roller. A transport path extends from the loading area exit to a card accumulation area. The transport path is further defined by two pairs of transport rollers, one roller of each pair above the transport path and one roller of each pair below the transport path. A camera is located between the two pairs of transport rollers, and a processor governs the operation of a digital camera and the rollers. A printer produces a record of the device's operation based on an output of the processor, and a portion of the transport path is illuminated by one or more blue LEDs. Preferably a low temperature source of light is located so as to illuminate the area of the card that is being scanned.

The computer or signal processor compiles the scan data and reports and records the result of the scans of all of the cards in the one or more decks. FIG. 15 of Purton illustrates how a card transport path 400 may be subdivided by locating baffles above or below the roller pairs in order to create distinct zones. Each zone may have a particular form of detector, polarimeter, diode or line scanner as well as a particular light source or lighting method. By locating sensors both above and below the transport path, both sides of the card may be examined simultaneously. This provides the opportunity to detect suit and value of an inverted card as well as increasing the sophistication with which tampering may be detected. Polarized light may be used to detect certain forms of tampering. In such a case, the polarity of the light source may be rotated during the detection process. Similarly, a non-polarized source may be moved during the detection process to create a moving shadow. One or more light sources may be movable or set to illuminate off-axis so that certain forms of scratches and pinholes may be more easily detected by their shadow or reflectance. It is contemplated that both color and monochrome imaging methods may provide useful information about the condition of the cards. Similarly both digital and analogue sensing methods are seen to have independent utility and functionality with regard to both suit and value detection as well as the detection of faults, wear and tampering. It should be noted that the compartmentalization of the card transport path into distinct lighting and sensing zones may be applied to any embodiment disclosed.

Published U.S. Patent Application Document No. 20050242500 (Downs III) describes a sensing system for determining the rank and suit of playing cards. The system includes a sensing module capable of reading a line of data from a printed image, a position sensor and a hardware component that combines the signals from the sensing module and position sensor, converts the signal to binary values and compares the converted signal to stored signals. The comparisons are correlated to identify card rank and Suit. The system can be used in a playing card delivery shoe used to control the game of baccarat. The shoe may be a customary dealing shoe equipped with a sensing module, or may be a mechanized shoe. The mechanized shoe may comprise a) an area for receiving a first set of playing cards useful in the play of the casino table card game of baccarat; b) first card mover that moves playing cards from the first set to a playing card staging area wherein at least one playing card is staged in an order by which playing cards are removed from the first set of and moved to the playing card staging area; c) second playing card mover that moves playing cards from the playing card staging area to a delivery area wherein playing cards removed from the staging area to the delivery shoe are moved in the same order by which playing cards were removed from the first set of playing cards and moved to the playing card staging area; and d) playing card reading sensors that read at least one playing card value of each playing card separately after each playing card has been removed from the area for receiving the first set of playing cards and before removal from the playing card delivery area One exemplary sensing system is a CIS line scanning system with an associated card position sensor and a FPGA hardware element.

Published U.S. Patent Application Document No. 20070018389 (Downs III) describes a method and an apparatus determines at least one of rank or suit of a playing card. The apparatus has at least one two-dimensional complementary metal oxide semiconductor imaging system that provides a signal when playing cards are moved over the system. The signal is a series of gray scale values that are converted into binary values. The sensed data is transmitted to a hardware component that identifies at least one of rank and suit to an external data storage device.

Published U.S. Patent Application Document No. 20070102879 (Stasson) describes a playing card shuffling device has a visual display in information communication with the playing card shuffling device. At least one processor is programmed to provide displayable information to the visual display indicative of an amount of time remaining or time expired in a procedure performed by the shuffling device. FIG. 1 shows a partial perspective view of the top surface of a first shuffling and card verification apparatus according to a practice of the invention. In this example of the invention, the device randomizes and/or verifies one or two decks of cards. The shuffling apparatus has a card accepting/receiving area that is preferably provided with a stationary lower support surface that slopes downwardly from the nearest outer side of the shuffling and verifying apparatus. A depression is provided in that nearest outer side to facilitate an operator's ability to place or remove cards into the card accepting/receiving area. The top surface of the shuffling and verifying apparatus is provided with a visual display (e.g., LED, liquid crystal, micro monitor, semiconductor display, multi-segment display, etc.), and a series of buttons, touch pads, lights and/or displays. These elements on the top surface of the shuffling and verifying device may act to indicate power availability (on/off), shuffler state (jam, active shuffling, completed shuffling cycle, insufficient numbers of cards, missing cards, sufficient numbers of cards, complete deck(s), damaged or marked cards, entry functions for the dealer to identify the number of players, the number of cards per hand, access to fixed programming for various games, the number of decks being shuffled, card calibration information, mode of operation (i.e. shuffling, verifying or both shuffling and verifying) and the like), or other information useful to the operator or casino. Among the non-limiting examples of these techniques are 1) a sensor so that when a pre-selected portion of the card (e.g., leading edge, trailing edge, and mark or feature on the card) passes a reading device, such as an optical reader, the bottom pick-off roller is directed to disengage, revolve freely, or withdraw from the bottom of the set of cards; 2) the first set of nip rollers or off-set rollers may have a surface speed that is greater than the surface speed of the bottom pick-off roller, so that engagement of a card applies tension against the bottom pick-off roller and the roller disengages with free rolling gearing, so that no forward moving forces are applied to the first card or any other card exposed upon movement of the first card; 3) a timing sequence so that, upon movement of the bottom pick-off roller for a defined period of time or for a defined amount of rotation (which correlates into a defined distance of movement of the first card), the bottom pick-off roller disengages, withdraws, or otherwise stops applying forces against the first card and thereby avoids applying forces against any other cards exposed by movement of the first card from the card accepting/receiving area 106 and 4) providing a stepped surface (not shown) between pick-off roller and off-set rollers 146 that contacts a leading edge of each card and will cause a card to be held up or retained in the event that more than one card feeds at a time.

Shuffler systems, especially those having a scanning system, can be converted to card inspections systems or may have card inspection systems according to the present technology integrated into the shufflers, randomizers and playing card delivery systems. Examples of such card moving systems include, but are not limited to U.S. Pat. Nos. 8,210,536; 8,210,535; 8,205,884; 8,191,894; 8,170,323; 8,150,875; 8,118,305; 8,109,514; 8,070,574; RE 42,944; 8,038,521; 8,025,294; 8,012,029; 8,011,661; 8,002,638; 7,988,152; 7,976,023; 7,971,881; 7,967,294; 7,950,663; 7,946,586; 7,933,448; 7,933,444; 7,854,430; 7,784,790; 7,769,232; 7,764,836; 7,753,373; 7,717,427; 7,699,694; 7,677,566; 7,677,565; 7,669,852; 7,597,623; 7,594,660; 7,593,544; 7,584,963; 7,584,962; 7,434,805; 7,413,191; 7,407,438; 7,384,044; 7,374,170; 7,367,884; 7,367,561; 7,338,044; 6,676,127; 6,659,461; 6,655,684; 6,651,982; 6,651,981; 6,588,750; and 6,588,750.

Other disclosures have also contemplated optically reading of playing cards. For example, U.S. Pat. Nos. 6,582,301; 6,039,650; and 5,722,893 to Hill et al. describes a shoe with a card scanner, which optically scans a playing card as the card moves out of shoe. The card suit and value is then recognized by a neural-network algorithm. Other disclosures have also attempted to track cards by use of card shoes that optically recognize the cards as they are drawn from the shoe. For example, U.S. Pat. Nos. 5,941,769 and 6,460,848 disclose a card shoe with an optical device that deflects and transmits a reflected image of the card value imprint from the drawn playing card to a CCD image converter. Still other disclosures have attempted to combine detection of playing cards optically and gambling chips by some means. For example, U.S. Pat. Nos. 5,605,334; 6,093,103 and 6,117,012 to McCrea et al., disclose a game table system for monitoring each hand in a progressive live card game. The system comprises a shoe that optically detects the value and suit of each card, a game bet sensor to detect the presence or absence of a bet, a card sensor located at each player position to detect the presence or absence of a playing card, and a game control. The game control receives information on the presence or absence of a bet or playing card to ensure a bet is placed before the playing card is dealt.

Published U.S. Patent Application Document No. 20100019449 (Downs III) describes how a playing card delivery shoe is used in the play of the casino table card game of baccarat or blackjack or any game where cards are pulled one at a time from the shoe. The apparatus comprises a reader or an imager that scans lines bisecting the image at spaced intervals. The scanning occurs on playing cards in at least the region where suit and rank symbols are provided. The scanner output is a series of voltages that are converted to binary information. This binary information is compared to stored binary information to determine rank and suit. The upper surface of the output end of the shoe contains a partial barrier for cards being scanned. The partial barrier has an elevated surface and limits a size of a pathway so that only one card can be removed at a time.

U.S. Pat. No. 6,460,848 (Soltys) describes a system that automatically monitors playing and wagering of a game, including the gaming habits of players and the performance of employees. A card deck reader automatically reads a symbol from each card in a deck of cards before a first one of the cards is removed. The symbol identifies a respective rank and suit of the card. There are numerous other related patents including U.S. Pat. Nos. 6,712,696; 6,688,979; 6,685,568; 6,663,490; 6,652,379; 6,638,161; 6,595,857; 6,579,181; 6,579,180; 6,533,662; 6,533,276; 6,530,837; 6,530,836; 6,527,271; 6,520,857; 6,517,436; and 6,517,435.

U.S. Pat. No. 8,119,975 (Downs III) describes a high speed deterministic, non-contact, 3-axis free trajectory measurement device and free trajectory imaging device. A data providing device associated with a trajectory sensing system has at least a frame. The frame supports at least two sensing receivers and at least one emitter for the sensing receivers. The sensors sense movement and/or position with respect to a surface. The frame supports a third sensor that senses information (e.g., image data) from the surface at least in addition to movement. There is also a communication link from the two sensing receivers to a data storage device; a communication link from the third sensor to a data storage device or to a processor and then a data storage device; and a processor that determines position of the system with respect to the surface based at least in part on data from the two sensing receivers. The emitters and sensors may be carried on a hand-held device in communication with a recorder or processor.

Robotic elements are minimally used in the field of gaming. In fact, the term is used loosely to cover almost any mechanical operation. For example, shuffling apparatus, automated dice casting systems (e.g., Published U.S. Patent Application Document No. 20110018194 (Nicely); Published U.S. Patent Application Document Nos. 20090118006, 20090118005; and 20090118001 (Bryan, including automated sensing of outcomes), automatic roulette systems and any simple mechanical element is considered a ‘robot.’ For example, in U.S. Patent Application Document No. 20070213112 (Humphrey) is disclosed an asserted robotic system in which there is a card game whereby pre-programmed computer players play a discrete number of hands of said card game and then the range of results is recorded. Then, at least one human player is allowed to play the exact same number of hands of said card game that the computer players previously played. Then, the result of how the human player performed is compared to range of results of the computer players (for instance by comparing chip counts, points, winnings, etc.). The human player becomes eligible to be awarded prizes based upon how well said human player performed relative to how the computer player(s) performed.

Bingotimes Digital Technology Co., Ltd. Markets a “robotic series” of gaming apparatus which is little more than an articulated shovel arm that moves a playing card, for example in a baccarat game.

Other systems known to be available for reading of card symbols (e.g., suits and rank) include at least WIPO Published Application WO/2000/051076 (Dolphin); Published U.S. Patent Application Documents No. 2011020175; 2010061342; 20040026636; and U.S. Pat. Nos. 6,726,205; 6,527,191; 6,533,276 and 8,020,869. All of the references cited herein are incorporated by reference in their entirety to provide enabling background for systems and technology and methods.

There are numerous programs, systems, tables, look-up tables, and strategies in memory that are known and available within the field of gaming. For example, U.S. Pat. Nos. 8,287,347 and 8,591,305 describes a program for allowing players an opportunity to conform play to optimum strategies that are stored in memory and compared to actual play of wagers and cards by the player. Published U.S. Patent Application Document No. 20120190423 (Yoseloff) describes a methodology for evaluating player performance, which requires knowledge of optimum playing card game play and strategy.

### SUMMARY OF THE INVENTION

A system for providing a method of entertainment to players of competitive card games using:
a) a source of randomized physical or virtual playing cards;
b) a processor having knowledge of card rank and suit order in the randomized playing cards;
c) the processor containing memory of game strategy for the competitive card games;
d) a mechanical or electromechanical card moving system for providing randomized playing cards to a player position and a dealer position;
e) a player input for providing wagers in the competitive card games;
f) the processor configured to exercise code to perform wagering events in the competitive card game based upon knowledge of card rank and suit order in the randomized playing cards and performance of the stored game strategy; and
g) the processor resolving wagers made in the competitive card games at conclusion of rounds of play in the competitive card games.

### BRIEF DESCRIPTION OF THE FIGURES

FIG. 1 shows a perspective view of a robotic gaming system 2 according to technology described and enabled herein.

FIG. 2 is a flow diagram according to one practice within the scope of the present technology.

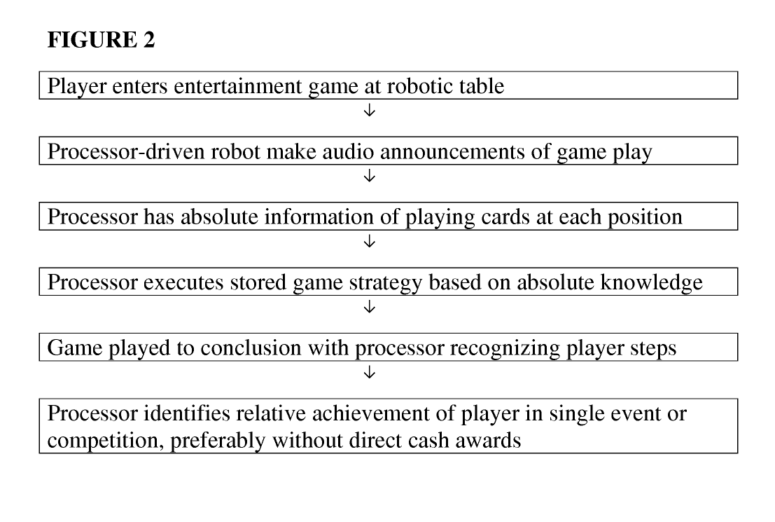

### DETAILED DESCRIPTION OF THE INVENTION

A system for providing entertainment to players of competitive card games has:
a) a source of randomized playing cards.

Where physical playing cards, the cards may be randomized and provided in a dealing shoe or as a shuffled set of playing cards placed on the gaming surface, such as a gaming table. Where virtual playing cards are provided as displayed images on one or more display screens, the random displays being provided by a random number generator and recall of images of playing cards from memory.
b) a processor having knowledge of card rank and suit order in the randomized playing cards.

The knowledge of the card rank and suit in the randomized playing cards (as delivered or before delivery of playing cards) may be provided by distribution from a known order of randomized playing cards or by reading of playing cards as they are delivered. The playing cards may be read before inserting into a delivery shoe, read during insertion into a delivery shoe, read while within the delivery shoe or read or read as delivered from a delivery shoe. Where a shuffling apparatus is used, the playing cards may be read as they are moved from an insert position into a randomization system (e.g., trays in a carousel or chambers in a stack); read as they enter chambers, trays or racks; read as they leave the chambers, trays or racks; or read as the cards enter or leave the delivery tray of the shuffler.
c) the processor containing memory of game strategy for the competitive card games.

As shown above, many different strategic systems are known and available for exercise of strategy, and electronic systems with strategy available for use in gaming equipment are known in the art. These systems are embedded in the software and memory executed or accessed by the processor with knowledge of the final position of the cards, their individual values and the ranks of hands at the various game positions (one or more player positions and a dealer or house position).
d) a manual or mechanical card moving system (or a manual removal system from a delivery tray or shuffling delivery tray) for moving randomized playing cards from the source of randomized playing cards to a player position and a dealer position.

Where the playing cards are provided in a delivery shoe, a manual removal and delivery action may be provided, either by a live player or by mechanical action from a robotic device (e.g., an arm on the robotic device with suction cups or grasping ‘fingers’ to move the cards.
e) a player input for providing wagers in the competitive card games.

The player input may be chips or tokens or electronic gaming wager entry system. The tokens may be read electronically (e.g., image reading by a camera, RFID, smart chip or the like) and manually moved to a wager position at the player position. The player input at the player position may be a tray or collection device that removes chips and/or awards chips from a supply (under table or robot controlled). For example, players may be provided with an initial number of gaming tokens (of preferably only nominal value, not convertible to currency) place amounts of their wager on a tray. The amount of the wager is provided to the processor by player input, RFID reading, visual reading and the like. The player resolves the wager on individual hands by, for example, lowering the tray with tokens on it and removing the tokens when there is a player loss, or alternatively lowering the tray or lowering a separate tray (e.g., with an elevator system that drops the tray below a gaming table surface) and adding tokens for a wager resolution when the player position wins the round of play. A live director at the gaming table may manually resolve wagers. A token delivery system (much like a slot machine payout system) may also be used to deliver tokens. A TITO (ticket-in-ticket-out) system with non-redeemable values thereon may also be used. The non-redeemable amounts on a TITO ticket may be used in wagering during the entertainment game.

If there is direct electronic-only wagering, simple processor controlled accounting functions can be used to address accounting outcomes on individual rounds of play and collective rounds of play. Wagers and resolutions may thus be handled in a completely electronic format to simplify the game.
f) the processor configured to exercise code to perform wagering events in the competitive card game based upon knowledge of card rank and suit order in the randomized playing cards and performance of the stored game strategy.

The processor plays out the game, much in the same manner that electronic, competitive gaming apparatus (e.g., video poker games) play out the game, except that in games such as Five-Card Stud, seven-card stud, seven-card hi-low, draw poker, Texas Hold'Em, Omaha poker and the like, where there are multiple wagering steps and the exercise of competitive strategy (e.g., larger wagers when the wager's hand knows it is winning, calling wagers when there is only a slight possibility of surpassing the opponent hand, etc.). Because the dealer position (with strategy exercised by the processor), any player should be apprised of the detailed knowledge available to the dealer position if actual value is being wagered. Because the system may be used for entertainment and not for wagering actual value, the degree of knowledge of the dealer need not be disclosed to players.
g) the processor resolving wagers made in the competitive card games at conclusion of rounds of play in the competitive card games.

As noted above and well known in the art, processors can be programmed and have access to memory to enable resolution of wagers according to game outcomes, especially with respect to playing card games such as poker and poker variants.

The present technology will be commercially introduced in phases, with each phase increasing in technical sophistication as a market develops for the underlying concepts of the invention.

Phase 1 would be the least technically sophisticated and the most manual labor intensive to perform. The system and operation of this phase would engage a live dealer to perform more complicated physical tasks, such as movement of playing cards and chips. For example, the components in phase one and the performance of each component could be summarized as follows:
a robotic component with an audio system;
a processor containing game strategy;
a set of randomized physical playing cards;
knowledge in the processor of the order of cards as they are delivered from the set of playing cards, whether or not faces of playing cards are exposed;
voice instructions in memory to direct execution of strategy directed by the processor's game strategy;
a live “dealer” to (possibly resolve wagers) physically move playing cards according to game rules to at least a player position, a dealer position and optional community card position; and
wagering positions for player wagers and dealer wagers (and possibly code that can be executed to resolve all wagers at conclusion of a round of play and provide accounting functions to determine outcomes and totals after multiple rounds of play.

In Phase 1, one or more, preferably 1, 2 or 3 players and up to 6 players would be in a competitive playing card game against the dealer, preferably a poker game, and especially Texas Hold'Em or Omaha Poker. Players and dealer make appropriate wagers in the ordinary play of the game, as is known for the particular competitive game. The live dealer moves playing cards to the appropriate player position(s) and dealer position. In Texas Hold'Em, for example, each player and the dealer positions would receive two (2) separate random playing cards from the randomized set of playing cards. The live dealer or the robot (through the audio system and stored vocal recordings) would request player activity on wagers, and the robot, by executing code regarding play strategy based on the knowledge in the processor of the playing cards in each hand on the basis of a) knowledge of the order of cards in the original set, b) knowledge of the cards immediately before delivery to positions on a gaming table, and/or c) knowledge of the individual playing cards are they are moved from the set of randomized playing cards to each game position (player(s) hand(s) or dealer hand).

Wagers are made (by players and dealer/robot) and additional playing cards are provided from the residual playing cards from the original set of playing cards (e.g., by the dealer) according to normal procedures and rules, as in traditional Texas Hold'Em Poker. The robot will announce its wagers, delivery of playing cards and other game moves and execution of strategies as might a human player. The strategies executed, as described in greater detail herein, is based on the knowledge of both player hand ranks, dealer hand ranks, probabilities of outcomes and (where all future cards to be played are known) with certain and absolute knowledge of outcomes.

Players may pay the casino or other establishment in a game challenging the “skill” of the robot against player skill The player may pay a fixed amount for a sum of nominal value chips or wagering value. The game may be played with these nominal value tokens accumulated or lost in a predetermined number of rounds of play (e.g., 2, 4, 5, 6, 8, 10, etc. rounds of play). At the conclusion of the predetermined number of rounds of play, the total value of the nominal value of the tokens for each player would be noted (e.g., the accounting function of the processor). The player would receive a slip, certificate or just electronic notice of the amount of final token value. Players can be given non-cash value awards for levels of success in single games or in tournaments (hourly, multi-hourly, daily, weekends or weekly or more). Some mechanism for legal award of cash value prizes can be provided, but this would make the device and system a gambling system, rather than an entertainment system. Both are within the scope of the present technology.

Phase 2 would seek to advance the system into a more automated system, with less interaction by a live dealer. For example, a delivery shoe with randomized playing cards may be inserted into and “arm” of the robot so that individual cards or groups of cards may be delivered from the arm (by a simple card moving system) to each required card position as required in game play. Tokens may be provided in another “arm” for appropriate wager delivery or bet removal (by suction cups, vacuum application or mechanical claw) as directed by the processor. The competitive games, strategies and resolutions would again be managed by the processor with knowledge of all individual and collective playing card suits and ranks, and all hand values according to the competitive game played.

Phase 3 would move towards the final, expected, fully electronic gaming systems described herein. Game play could still be individual players against the robot, multiple players against the robot, individual sessions or tournament play.

Robots may have different levels of activity, from merely providing verbal commands, activating buttons to initiate verbal commands or comments, move game pieces (arms moving cards or tokens/chips/tickets). The competition is, as previously indicated, preferably for entertainment value, although it could be educational (e.g., for teaching the competitive playing card game), and different levels of skill (different qualities of strategies) can be available to the processor. These different levels of skill in the processor may be used for the different types of events. For example, in training mode, the lowest level of skill may be exercised by the processor, even with knowledge of all playing cards in the round. In tournament play, the highest level of skill may be used, or blends (preferably randomly) may be used with knowledge of the playing cards.

The play of the game may be advertised, for example, as:
STRUGGLE BETWEEN MAN AND MACHINE
ADVANCE OF SMART ROBOTS
ADVANCE OF ARTIFICIAL INTELLIGENCE, and the like.

A relatively completely robotic system for providing entertainment to players of competitive card games may be constructed with:
a) a source of randomized playing cards;
b) a processor having knowledge of card rank and suit order in the randomized playing cards;
c) the processor containing memory of game strategy for the competitive card games;
d) a mechanical card moving system (preferably associated with the dealer position) for making randomized playing cards from the source of randomized playing cards available to a player position and a dealer position. The robotic system may be animated to enhance the gaming entertainment experience, including but not limited to audio capability using a human voice.
e) a player input for providing wagers in the competitive card games;
f) the processor configured to exercise code to perform wagering events in the competitive card game based upon knowledge of card rank and suit order in the randomized playing cards and performance of the stored game strategy;
g) a robotic device simulating a dealer at the dealer position; and
h) the processor resolving wagers made in the competitive card games at conclusion of rounds of play in the competitive card games.

The robotic system may use a robotic device with an audio system that provides language output from the memory relating to events in the competitive games. The audio emissions may relate to the play of the game, include cordial comments, joking comments, commentary on the game, description of displayed playing cards, and other types of terms that can interact with the live player(s) to create entertainment value. The robotic content might be only a display screen with an image of the dealer, but this is a least preferred embodiment. An actual mechanical, electromechanical robotic device is highly desirable in the practice of the present technology, with either male, female or androgynous attributes. A preferred robotic system may have a head, torso and at least one moveable arm, with movement of the at least one moveable arm controlled by the processor.

The robotic system engages in performance of wagering events in the competitive card game and is preferably based upon knowledge of card rank and suit order in the randomized playing cards as delivered to the player position and the dealer position and performance of the stored game strategy.

The robotic system is preferably used in conjunction with a competitive game that is a playing card poker game and the wagers are resolved on the basis of respective poker ranks in the player position and the dealer position. Any competitive poker playing card game is useful. A competitive poker game is one in which a dealer hand competes with a player hand, as opposed to a player playing only against a paytable (as in Let It Ride® poker. A paytable may be available in the present system in conjunction with the competitive game. In a preferred competitive game, if a player uses a wager against a paytable, the competitive dealer hand will also wager against a paytable.

The robotic system may have the processor execute code to provide audio information identifying at least game play strategy being performed by the processor in the competitive game of poker, in addition to general conversation and other communication similar to that which might occur at a gaming table. The robotic system also may use the processor to execute code to provide the audio information identifying at least game play strategy being performed by the processor in the competitive game of poker. To assure a balance in a competition between a live player and the robotic system of the present technology, the processor may execute code that prohibits bluffing wagering against a player when the processor recognizes that a hand of playing cards at the dealer position is a higher poker rank than a poker rank at a hand at a player position.

A method of playing a game of entertainment on a robotic system, including those described herein may be used to provide entertainment to players of competitive card games by:
a) providing a source of randomized playing cards;
b) a processor determining knowledge of card rank and suit order in the randomized playing cards;
c) the processor containing memory of game strategy for the competitive card games;
d) a mechanical card moving system making randomized playing cards available from the source of randomized playing cards available to a player position and a dealer position;
e) a player inputting wagers in the competitive card games;
f) the processor executing code to perform wagering events in the competitive card game based upon knowledge of card rank and suit order in the randomized playing cards and performance of the stored game strategy;
g) a robotic device simulating a dealer at the dealer position; and
h) the processor resolving wagers made in the competitive card games at conclusion of rounds of play in the competitive card games;

the game being played with only non-economic value wagers. The method may have all playing cards as randomized virtual playing cards displayed at the dealer position on a display device. The method may use all playing cards are physical playing cards provided to the dealer position and the player position. The method may also have the physical playing cards provided from a dealer shoe containing randomized playing cards or from a playing card randomizing system that provides randomized playing cards for distribution to the dealer position and the player position.

The following detailed prophetic example describes one method of play and a system within the scope of the present invention.

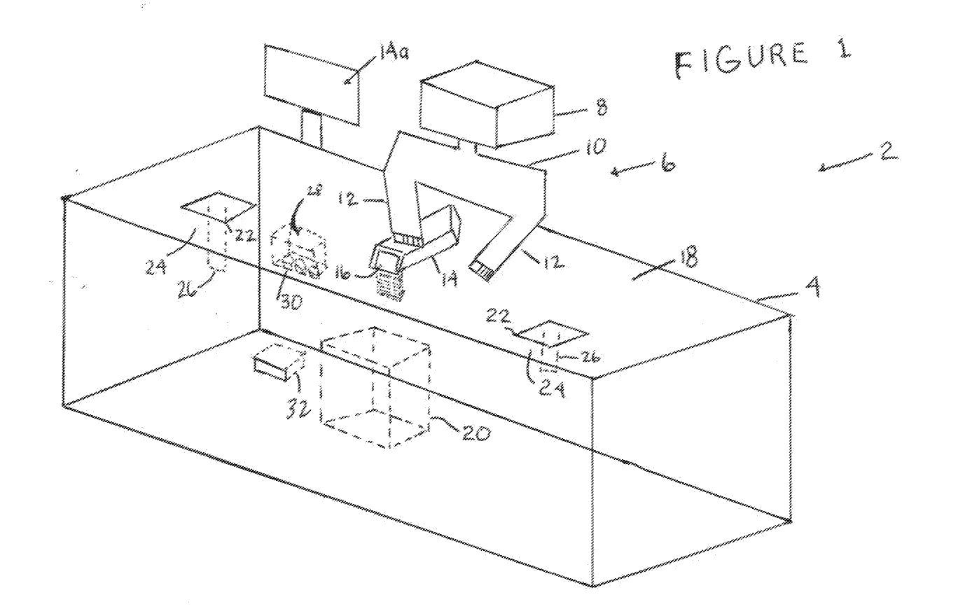

FIG. 1 shows a perspective view of a robotic gaming system 2 according to technology described and enabled herein. The robotic gaming system 2 is shown with at least component parts of:
a gaming table 4;
a robotic simulated dealer 6 as head 8, torso 10 and arms 12;
a playing card dispensing tray 14 with playing cards 16 provided from under the surface 18 of the gaming table 4 and an optional display screen 14a for display of virtual playing cards;
a processor 20 under the gaming table 4;
a wagering plate 22 at a player position 24 opposite the robotic simulated dealer 6;
an elevator system 26 under the gaming table 4 and associated with the wagering plate 22;
a source 28 of tokens 30 associated with the elevator system 26 to store tokens 30 both from capture from player losses and to provide to players upon player winning outcomes; and
a ticket printer 32 for providing information on player winning outcomes or final player winning/losing status.

A game of Texas Hold'Em poker may be played according to the following steps. A player seated at the gaming table (the player having non-economic value tokens with which to wager) places a wager on a wager plate associated with an elevator that lowered itself below the table surface. Upon placement of the wager, two playing cards are dealt (e.g., face down) to individual player positions and the dealer position. The appropriate position (as defined by the rules of Texas Hold'Em or in a single player versus dealer game, the player position) may make the first wager. The amount of the wager in known to the processor and according to stored strategy software executed by the processor with knowledge of the value, suit and rank of all playing cards dealt (and even future cards that will be displayed or provided to the community set of playing cards) make a responsive or initial game wager. Initial wagers or intermediate wagers may remain on the wagering tray or may be withdrawn under the table, or as is done on a standard gaming table, all wagers from all sources accumulated on one or more wagering trays.

The present technology may include many variations within the scope of the present technology, and remain a unified invention. Among the variations that may be practiced are at least the following:

A set of physical playing cards may be provided at the robot dealer gaming table. This may be accomplished by providing a source of a first set of random playing cards. As explained in greater detail herein, the random set of cards may be provided by a pre-randomized (e.g., shuffled) playing cards, a shuffling device that would provide (e.g., in a delivery tray) one card at a time, sets of playing cards in exact numbers (e.g., 2 for player and dealer and then, sequentially three, one and one for Texas Hold'em as an example), or providing a continuous stream of random playing cards (e.g., a continuous shuffler) which are individually distributed by a dealer. The shuffling may be performed by a number of various methods, including manual shuffling to produce a randomized set of playing cards. The automatic shufflers may operate by either actually shuffling a portion of or entire set of playing cards (e.g., one or more decks of playing cards), or by providing hands or subsets of playing cards randomly out of the original complete set of playing cards. The cards may be batch shuffled or continuously shuffled (returned, spent cards from previous hands are returned to the machine and randomly distributed among cards already in the machine). The shuffling mechanism may be accomplished by use of carousels (or linear moving stacked arrays) of multiple compartments into which cards are inserted (randomly or in predetermined locations among the compartments) and then unloaded from the compartments (randomly or in predetermined order of compartments) so that random hands or subsets of playing cards are distributed to a delivery area for distribution by the dealer. The cards may also be delivered to a delivery tray by random removal (e.g., random ejection as understood in the art, or random removal by any other technology) from the original set and delivery of the randomly withdrawn/removed cards to the delivery tray to form random hands or random subsets in the delivery tray.

The distribution of the physical playing cards (as opposed to the use of virtual playing cards distributed to viewing surfaces on the gaming table or other electronic gaming devices by a processor using a random number generator to select random playing cards, rather than a physical shuffler) may be done by a physical operator, either a skilled or un skilled dealer, or even a player. The player may deliver the cards when the playing cards are read prior to delivery, so that ultimate card positions are known in advance of delivery. This would eliminate fraud by the player, and if fraud were committed, both the individual hand and the event would be called void. The cards may be mechanically distributed by robotic means or other (conveyor) physical mechanisms, but manual delivery is the simplest format.

The chips or wagering components may also be manually delivered for the robotic dealer and, of course for the player position. The use of electronic wager entry terminals, with an accounting function in the processor are desirable. The player may make manual entries (or oral commands received by the terminal) and the amounts of the wagers and even visual images of stacks of chips wagered may be displayed. The wagering terminals can eliminate the need for gaming chips. When gaming chips are used, numerous security and control technologies currently available may be used. This includes image recognition of chips in, out of and anywhere about the gaming table. In addition, RFID sensing systems, and weighing systems such as those disclosed in copending U.S. patent application Ser. No. 14/703,887 (Electronic Gaming Systems with Physical Gaming Chips and Wager Display), filed May 2015 in the name of Mladen Blazevic, which is incorporated by reference in its entirety. Chips and cards and any other gaming elements will generally remain on or about the gaming table. The chips may be dedicated (e.g., non-absolute value chips) to the robotic game table so that they may not be confused with normal casino wagering chips and so that normal casino wagering chips may not be brought into the game. As there may be special awards offered on the robotic table, there should be no possibility of general casino chips being used in the game. Again, automated wagering on electronic terminals can overcome this problem.

The robot figure can be configured will play using poker playing software with added features which will recognize amount of chips (dealer's/robot's and player's) to allow bluffing. Systems and software for best gaming strategies are well known in the industry. These best strategy systems can be incorporated into the game. Especially where the system is aware of player cards and robot's cards, bluffing is enabled by the robot. As the wagering event between player(s) and robotic position dealer is not likely to be a controlled gaming event normally falling under Gaming Jurisdiction guidelines, this advantage and knowledge, whether or not publicized, can be acceptable.

The robot may be configured with speakers and an audio card so that audio communication and announcements can seem to be made by the robot. These announcements can be made automatically, depending upon the decisions made by the gaming strategy software. The amounts of wagers, and other actions may be made. The robot may be programmed with canned phrases may be stored to be provided at appropriate times. Phrases may even be available to suggest or hint to players that bluffing or absolute knowledge of player value hands is known. This kind of “trash talk” is common at poker tables and would help create a realistic game environment. A live table manager/dealer can also initiate these announcements or initiate decisions by pushing the buttons or talking.

The machine vision system over the table (s generally described in the cited U.S. patent application Ser. No. 14/703,887, cited above and in the background of the art in that application) will recognize cards (flop, robot's and possibly player's) and calculate chips in the trays. Any other visual identification system for the cards and chips (e.g., eye-in-the-sky card readers, card scanners in the shufflers or dealing shows, card readers on or in the table top, and the like) may be used.

The system may enable 2 levels of play:
1. using only good poker playing software
2. using good poker playing software and player's card recognition (enabling processor knowledge of player and robotic dealer hands and wagers and strategy.

The system may be used ONLY for entertainment purpose: so that players can play a number of hands, or play until certain limits are met (e.g., player at least doubles an initial stake or loses at least 50% of an initial stake) and if they win, according to defined standards, such as taking all money from the robotic player in a certain number of hands, the player is declared a winner. Various prizes may be randomly awarded, independent of a degree of winning outcome, or prizes may be based on a level of success. For example, one out of a hundred wins against the robot in which the player accumulates all robot funds may be a free entry into a tournament. Other prizes such as nights at the casino, additions to comp cards, free meals, etc. may be provided.

Wagers progress in the game as additional communal playing cards are provided to the communal area. A final resolution for a player may occur after a predetermined number of hands or a predetermined time.

The technology further includes robotic system for providing entertainment to players of competitive card games having:
a) a source of randomized playing cards;
b) a processor having no knowledge of card rank and suit order in the randomized playing cards;
c) the processor containing memory of game strategy for the competitive card games;
d) a source of randomized playing cards for providing randomized playing cards to a player position and a dealer position;
e) a player input for providing wagers in the competitive card games;
f) the processor configured to exercise code to perform wagering events in the competitive card game based upon only random activity and/or performance according to the stored game strategy;
g) a robotic device simulating a dealer at the dealer position; and
h) the system resolving wagers made in the competitive card games at conclusion of rounds of play in the competitive card games.

The system may have chip reading technology is present enabling reading and accounting of wagers, total chip value held by a player and total chip value held by at the dealer position. The source of randomized playing cards is a shuffler or storage shoe configured to allow removal of one or more playing cards for manual delivery to a player position and a dealer position. The system may use gaming chips that have no negotiable value in the casino and resolution of the a final accounting of player chip total after at least one of a specific number of hands, a specific amount of time, or a specific total in player chips is accomplished by selection of a random award selected from a set of available awards.

What is claimed:

1. A system for providing entertainment to players of competitive card games comprising:
a) a source of randomized playing cards;
b) a processor having knowledge of card rank and suit order in the randomized playing cards;
c) the processor containing memory of game strategy for the competitive card games;
d) a mechanical card moving system for moving randomized playing cards from the source of randomized playing cards to a player position and a dealer position;
e) a player input for providing wagers in the competitive card games;
f) the processor configured to exercise code to perform wagering events in the competitive card game based upon knowledge of card rank and suit order in the randomized playing cards and performance of the stored game strategy; and
g) the processor resolving wagers made in the competitive card games at conclusion of rounds of play in the competitive card games.

2. A robotic system for providing entertainment to players of competitive card games comprising:
a) a source of randomized playing cards;
b) a processor having knowledge of card rank and suit order in the randomized playing cards;
c) the processor containing memory of game strategy for the competitive card games;
d) a mechanical card moving system for making randomized playing cards from the source of randomized playing cards available to a player position and a dealer position;
e) a player input for providing wagers in the competitive card games;
f) the processor configured to exercise code to perform wagering events in the competitive card game based upon knowledge of card rank and suit order in the randomized playing cards and performance of the stored game strategy;
g) a robotic device simulating a dealer at the dealer position; and
h) the processor resolving wagers made in the competitive card games at conclusion of rounds of play in the competitive card games.

3. The robotic system of claim 2 wherein the robotic device has an audio system that provides language output from the memory relating to events in the competitive games.

4. The robotic system of claim 3 wherein the robotic device comprises a head, torso and at least one moveable arm, with movement of the at least one moveable arm controlled by the processor.

5. The robotic system of claim 3 wherein performance of wagering events in the competitive card game is based upon knowledge of card rank and suit order in the randomized playing cards as delivered to the player position and the dealer position and performance of the stored game strategy.

6. The robotic system of claim 4 wherein performance of wagering events in the competitive card game is based upon knowledge of card rank and suit order in the randomized playing cards as delivered to the player position and the dealer position and performance of the stored game strategy.

7. The robotic system of claim 2 wherein the competitive game is a playing card poker game and the wagers are resolved on the basis of respective poker ranks in the player position and the dealer position.

8. The robotic system of claim 4 wherein the competitive game is a playing card poker game and the wagers are resolved on the basis of respective poker ranks in the player position and the dealer position.

9. The robotic system of claim 3 wherein the competitive game is a playing card poker game and the wagers are resolved on the basis of respective poker ranks in the player position and the dealer position.

10. The robotic system of claim 6 wherein the competitive game is a playing card poker game and the wagers are resolved on the basis of respective poker ranks in the player position and the dealer position.

11. The robotic system of claim 3 wherein the processor executes code to provide audio information identifying at least game play strategy being performed by the processor in the competitive game of poker.

12. The robotic system of claim 4 wherein the processor executes code to provide audio information identifying at least game play strategy being performed by the processor in the competitive game of poker.

13. The robotic system of claim 6 wherein the processor executes code to provide audio information identifying at least game play strategy being performed by the processor in the competitive game of poker.

14. The robotic system of claim 6 wherein the processor executes code that prohibits bluffing wagering against a player when the processor recognizes that a hand of playing cards at the dealer position is a higher poker rank than a poker rank at a hand at a player position.

15. The robotic system of claim 9 wherein the processor executes code that prohibits bluffing wagering against a player when the processor recognizes that a hand of playing cards at the dealer position is a higher poker rank than a poker rank at a hand at a player position.

16. A method of playing a game of entertainment on a robotic system for providing entertainment to players of competitive card games comprising:
a) providing a source of randomized playing cards;
b) a processor determining knowledge of card rank and suit order in the randomized playing cards;
c) the processor containing memory of game strategy for the competitive card games;
d) a mechanical card moving system making randomized playing cards available from the source of randomized playing cards available to a player position and a dealer position;
e) a player inputting wagers in the competitive card games;
f) the processor executing code to perform wagering events in the competitive card game based upon knowledge of card rank and suit order in the randomized playing cards and performance of the stored game strategy;
g) a robotic device simulating a dealer at the dealer position; and
h) the processor resolving wagers made in the competitive card games at conclusion of rounds of play in the competitive card games;
the game being played with only non-economic value wagers.
i) The method of claim 16 wherein all playing cards are randomized virtual playing cards displayed at the dealer position on a display device.
j) The method of claim 16 wherein all playing cards are physical playing cards provided to the dealer position and the player position.
k) The method of claim 18 wherein the physical playing cards are provided from a dealer shoe containing randomized playing cards or from a playing card randomizing system that provides randomized playing cards for distribution to the dealer position and the player position.

17. A robotic system for providing entertainment to players of competitive card games comprising:
i) a source of randomized playing cards;
j) a processor having no knowledge of card rank and suit order in the randomized playing cards;
k) the processor containing memory of game strategy for the competitive card games;
l) a source of randomized playing cards for providing randomized playing cards to a player position and a dealer position;
m) a player input for providing wagers in the competitive card games;
n) the processor configured to exercise code to perform wagering events in the competitive card game based upon only random activity and/or performance according to the stored game strategy;
o) a robotic device simulating a dealer at the dealer position; and
p) the system resolving wagers made in the competitive card games at conclusion of rounds of play in the competitive card games.

18. The system of claim 17 wherein the source of randomized playing cards is a shuffler or storage shoe configured to allow removal of one or more playing cards for manual delivery to a player position and a dealer position.

19. The system of claim 18 wherein chip reading technology is present enabling reading and accounting of wagers, total chip value held by a player and total chip value held by at the dealer position.

20. The system of claim 19 wherein the gaming chips have no negotiable value in the casino and resolution of the a final accounting of player chip total after at least one of a specific number of hands, a specific amount of time, or a specific total in player chips is accomplished by selection of a random award selected from a set of available awards.
